(19) United States
(12) Patent Application Publication
(10) Pub. No.: US 2003/0017897 A1
(43) Pub. Date: Jan. 23, 2003

(54) Bicycle transmission assembly

(76) Inventor: Po-Wen Hsiao, Shern Gang Hsiang (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 09/908,074

(22) Filed: Jul. 18, 2001

(51) Int. Cl. F16H 55/12; F16H 55/30; G05G 1/14

(52) U.S. Cl. 474/160; 74/594.4

(57) ABSTRACT

A bicycle transmission assembly comprises a freewheel mounted to a bottom bracket axle driven by the pedals. A transmission member is securely mounted on an axle for driving the rear wheel and connected to the freewheel on the bottom bracket axle. The transmission member has a reduced volume to thereby reduce the overall volume of the transmission assembly and the overall weight of the bicycle and thereby allow easy maintenance and replacement of the freewheel.

### BACKGROUND OF THE INVENTION

1. Field of the Invention

The present invention relates to a bicycle transmission assembly having a freewheel mounted to a bottom bracket axle driven by the pedals, thereby reducing the overall volume of the transmission assembly and the overall weight of the bicycle and allowing easy maintenance and replacement of the freewheel.

2. Description of the Related Art

A typical bicycle comprises a freewheel that is rotatably mounted to a rear axle of the bicycle without any shield. As a result, the grease on the freewheel for lubrication is apt to be washed away by rain, which speeds up wear to the freewheel and thus shortens the life of the freewheel. Conventional bicycle transmission assemblies are bulky and thus adversely affect the steering maneuverability and aesthetic appearance, and the bulky transmission assemblies are not suitable to small bicycles. Maintenance and replacement of the freewheel are inconvenient and time consuming, as many elements have to be detached. In addition, it is difficult to maintain the precision of verticality of the chain wheel of a conventional bicycle transmission assembly integral with one of the pedals. As a result, the chain wheel will sway to a considerable extent and thus adversely affect pedaling if the chain wheel cannot be keep exactly vertical.

### SUMMARY OF THE INVENTION

An object of the present invention is to provide a bicycle transmission assembly having a freewheel mounted to a bottom bracket axle driven by the pedals, thereby reducing the overall volume of the transmission assembly and the overall weight of the bicycle and allowing easy maintenance and replacement of the freewheel.

Another object of the present invention is to provide a bicycle transmission assembly with a reduced volume by means of reducing the volume of a transmission member that connects the freewheel on the bottom bracket axle to an axle for driving the rear wheel of the bicycle.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a bicycle transmission assembly in accordance with the present invention.

FIG. 2 is an exploded perspective view of the bicycle transmission assembly in accordance with the present invention.

FIG. 3 is a sectional view taken along line A-A in FIG. 1.

FIG. 4 is a schematic view illustrating a bicycle with the bicycle transmission assembly in accordance with the present invention.

### DETAILED DESCRIPTION OF THE PREFERRED EMBODIMENT

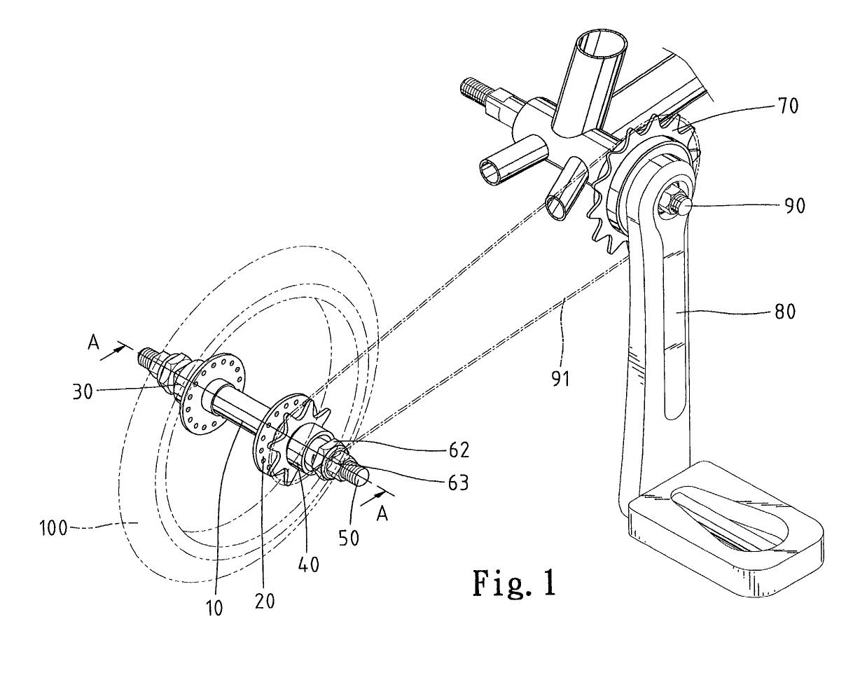

Referring to FIGS. 1 through 3, a bicycle transmission assembly in accordance with the present invention generally comprises an axle-tree 50 having first and second threaded ends 52 and an intermediate portion 51. A hollow axle 10 is rotatably mounted around the intermediate portion 51 and a part of each threaded end 52 of the axle-tree 50 and comprises a first end 15 having an outer threading and a second end 11 having an outer threading 13. The hollow axle 10 further comprises two longitudinally spaced stepped portions 12 and a longitudinal hole 14 through which the axle-tree 50 extends.

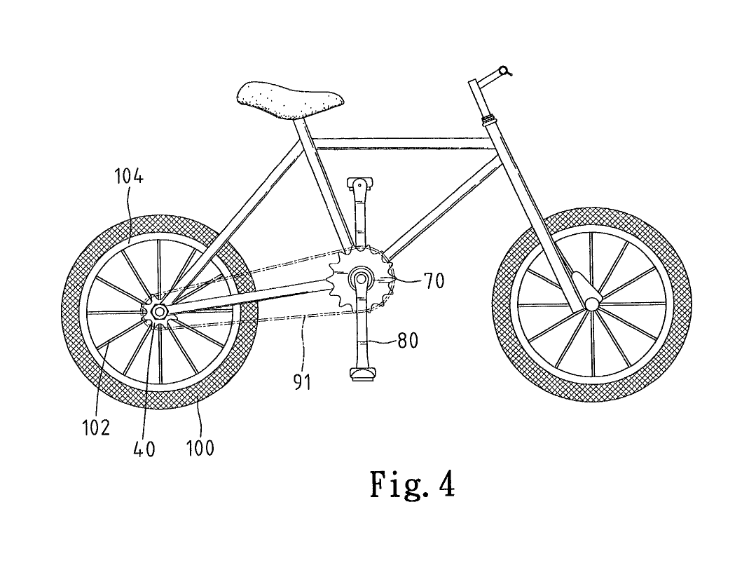

First and second hubs 20a and 20b are mounted around the axle-tree 50 (see the hole 21 in each hub 20) and each include a flange 22 bearing against a respective stepped portion 12. Each hub 20a, 20b further includes a plurality of circumferentially spaced spokes 23 each for engaging with an end of a respective spoke 102 (FIG. 4), the other end of which is engaged to a respective nipple (not shown) on a rim 104 of a rear wheel 100 (FIG. 4.

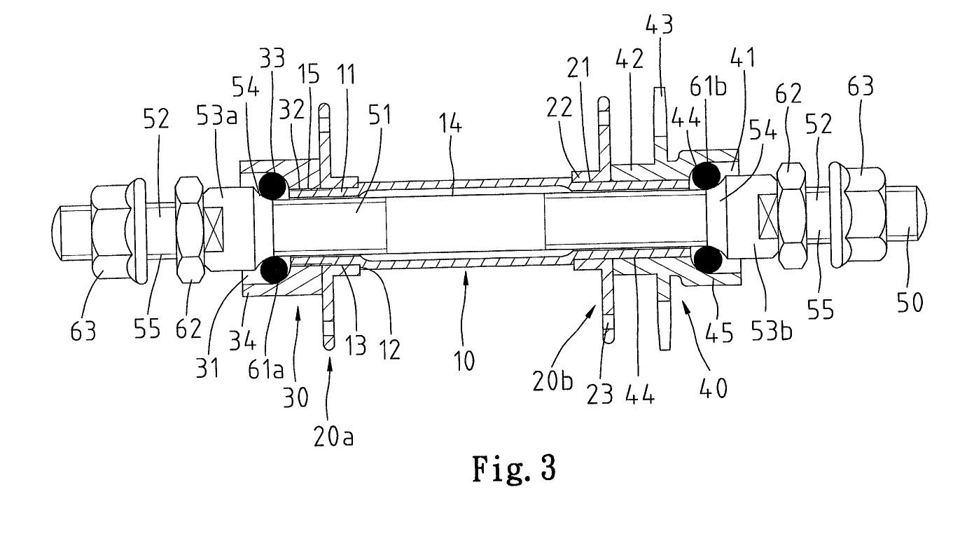

A transmission member 40 is securely mounted around the second end 11 of the axle 10 to press the first hub 20b (the right one in FIG. 3) against a respective stepped portion 12. In this embodiment, the transmission member 40 comprises a through-hole (not labeled) through which the axle 10 extends. The through-hole of the transmission member 40 comprises a first end 42 with an inner threading 44 (FIG. 3) for threading engagement with the outer threading 13 of the second end 11 of the axle 10 and a second end 45 defining a bearing-receiving space 41 for receiving a bearing 61b. It is noted that the second end 45 of the transmission member 40 is extended through by the second threaded end 52 of the axle-tree 50. The transmission member 40 further comprises a plurality of teeth 43 (preferably about 8-9 teeth) on an outer periphery thereof. A first stop 53b is threadedly engaged to the second threaded end 52 of the axle-tree 50 to thereby retain the bearing 61b in the bearing-receiving space 41. The first stop 53b comprises a bearing-supporting face 54 on an inner end thereof. The balls (not labeled) of the first bearing 61b are rotatably supported between the bearing-supporting face 54 of the first stop 53b and a bearing-supporting face 44 defining a portion of the bearing-receiving space 41 of the transmission member 40. A washer 62 and a nut 63 are then mounted to the second threaded end 52 of the axle-tree 50 to prevent disengagement of the first stop 53b and the corresponding elements, best shown in FIG. 3.

A bearing holder 30 is threadedly engaged around the first end 15 of the axle 10 to press the second hub 20a (the left one in FIG. 3) against a respective stepped portion 12. In this embodiment, the bearing holder 30 comprises a through-hole (not labeled) through which the axle 10 extends. The through-hole of the bearing holder 30 comprises a first end with an inner threading 32 for threading engagement with the outer threading of the first end 15 of the axle 10 and a second end 34 defining a bearing-receiving space 31 for receiving a second bearing 61a identical to the first bearing 61b. It is noted that the second end 34 of the bearing holder 30 is extended through by the first threaded end 52 of the axle-tree 50. A second stop 53a is threadedly engaged to the first threaded end 52 of the axle-tree 50 to thereby retain the second bearing 61a in the bearing-receiving space 31. In addition, the second stop 53a comprises a bearing-supporting face 54 on an inner end thereof. The balls (not labeled) of the second bearing 61a are rotatably supported between the bearing-supporting face 54 of the second stop 53a and a bearing-supporting face 33 defining a portion of the bearing-receiving space 31 of the bearing holder 30. Another washer 62 and another nut 63 are then mounted to the first threaded end 52 of the axle-tree 50 to prevent disengagement of the second stop 53a and the corresponding elements, best shown in FIG. 3.

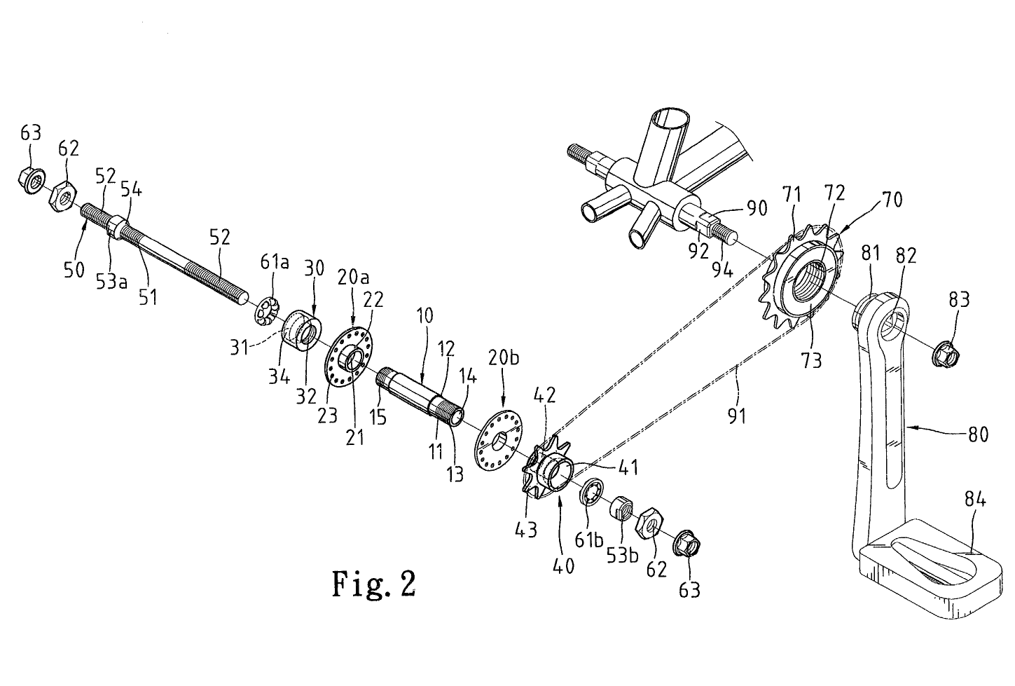

Referring to FIGS. 2 and 4, the bicycle transmission assembly in accordance with the present invention further comprises a freewheel 70 securely mounted to a bottom bracket axle 90 driven by the pedals 84 (only one is shown). In this embodiment, as illustrated in FIG. 2, each pedal 84 is attached to an end of a crank 80. The other end of the crank 80 comprises a threaded portion 81 with a non-circular hole 82 that engages with a respective non-circular portion 92 of the bottom bracket axle 90, and a nut 83 is threadedly engaged with the respective threaded portion 94 of the bottom bracket axle 90 to prevent disengagement of the crank 80. The freewheel 70 comprises a disc 73 with a screw hole 72 for threading engagement with the threaded portion 81 of the corresponding crank 80. Thus, the freewheel 70 and the bottom bracket axle 90 are turned when pedaling. The freewheel 70 further includes a gear portion 71 surrounding the disc 73. The gear portion 71 of the freewheel 70 comprises about fourteen (14) teeth, which is much smaller than that of a conventional freewheel. The disc 73 of the freewheel 70 rotates freely and the gear portion 71 does not turn when the pedals 84 are pedaled in a rearward direction.

A chain 91 is wound around the gear portion 71 of the freewheel 70 and the teeth 43 of the transmission member 40. Thus, when the pedals 84 are pedaled forward, the rear wheel 100 is driven to move forward via transmission by the transmission member 40, the axle 10, the hubs 20, and the spokes 102 of the rear wheel 100. The axle-tree 50 is fixed, and the bearings 61a and 61b allow relative rotation between the axle-tree 50 and the rotatable elements 10, 20, and 40.

According to the above description, it is appreciated that the overall volume of the transmission assembly in accordance with the present invention is much smaller than that of conventional designs. This is achieved by arranging the freewheel 70 on the bottom bracket axle 90. In addition, the volume of the transmission member 40 is also reduced to have only about eight (8) teeth. The overall weight of the bicycle as well as its cost is also reduced. In addition, detachment of the transmission assembly can be easily and quickly achieved when compared with conventional designs. Maintenance and replacement of the freewheel can be achieved easily and quickly. Further, by means of arranging the freewheel 70 on the bottom bracket axle 90, the diameter of the freewheel 70 is reduced by almost a half when compared with the conventional designs, the assembly procedure of the transmission assembly is more simple. The verticality and maneuverability of the gear portion 71 of the freewheel 70 during pedaling can be controlled precisely while reducing the possibility of undesired disengagement and/or jam of the chain 91. Further, the freewheel 70 mounted on the bottom bracket axle 90 may obtain a better shield by a simple so-called “half chain shield.” Thus, the freewheel 70 can be kept in a well-lubricated state without the risk of washing away of the grease, thereby prolonging the life of the freewheel.

Although the invention has been explained in relation to its preferred embodiment, it is to be understood that many other possible modifications and variations can be made without departing from the scope of the invention as hereinafter claimed.

What is claimed is:

1. A bicycle transmission assembly comprising:
a freewheel mounted to a bottom bracket axle of a bicycle;
an axle for driving a rear wheel of the bicycle; and
a transmission member mounted to the axle to rotate therewith, the freewheel being operably connected to the transmission member such that the transmission member is turned when the freewheel rotates.

2. The bicycle transmission assembly as claimed in claim 1, wherein the freewheel comprises a disc and a gear portion mounted around the disc, the disc and the gear portion being so arranged that the disc and the gear portion are turned in a forward direction when two pedals of the bicycle are pedaled in the forward direction and that the disc rotates freely and the gear portion is not turned when the pedals of the bicycle are pedaled in a rearward direction.

3. The bicycle transmission assembly as claimed in claim 2, wherein the bottom bracket axle comprises an end having a non-circular portion and a threaded portion, further comprising a crank connecting one of the pedals to the end of the bottom bracket axle, the crank comprising an end having a threaded portion with a non-circular hole for engaging with the non-circular portion of the bottom bracket axle, the disc of the freewheel comprising a screw hole for threading engagement with the threaded portion of the crank.

4. The bicycle transmission assembly as claimed in claim 1, wherein the axle is hollow and comprises a first end with an outer threading and a second end with an outer threading, the transmission member comprising a through-hole through which the axle extends, the through-hole of the transmission member comprising a first end for threading engagement with the outer threading of the second end of the axle, the through-hole of the transmission member further comprising a second end defining a bearing-receiving space for receiving a bearing, further comprising an axle-tree extending through the axle and the bearing-receiving space of the transmission member, the bearing-receiving space of the transmission member including a first bearing-supporting face, a stop being threadedly engaged on the axle-tree and including a second bearing-supporting face that cooperates with the first bearing-supporting face to rotatably support the bearing.

5. The bicycle transmission assembly as claimed in claim 4, wherein the axle comprises a stepped portion, further comprising a hub mounted around the axle, the stop being turned to move transmission member to a position pressing the hub against the stepped portion.

6. The bicycle transmission assembly as claimed in claim 5, wherein the hub comprises a plurality of circumferentially spaced spoke holes.

7. The bicycle transmission assembly as claimed in claim 6, wherein the axle further comprises a second stepped portion, further comprising a second hub mounted around the axle and pressing against the second stepped portion, a bearing holder being threadedly engaged with the outer threading of the first end of the axle, the bearing holder comprising a through-hole through which the axle extends, the through-hole of the bearing holder comprising a first end for threading engagement with the outer threading of the first end of the axle, the through-hole of the bearing holder further comprising a second end defining a second bearing-receiving space for receiving a second bearing, the axle-tree extending through the second bearing-receiving space of the bearing holder, the second bearing-receiving space of the bearing holder including a third bearing-supporting face, a second stop being threadedly engaged on the axle-tree and including a fourth bearing-supporting face that cooperates with the third bearing-supporting face to rotatably support the second bearing.

8. The bicycle transmission assembly as claimed in claim 7, wherein the second stop is turned to move the bearing holder to a position pressing the second hub against the second stepped portion.

9. The bicycle transmission assembly as claimed in claim 2, wherein the axle is hollow and comprises a first end with an outer threading and a second end with an outer threading, the transmission member comprising a through-hole through which the axle extends, the through-hole of the transmission member comprising a first end for threading engagement with the outer threading of the second end of the axle, the through-hole of the transmission member further comprising a second end defining a bearing-receiving space for receiving a bearing, further comprising an axle-tree extending through the axle and the bearing-receiving space of the transmission member, the bearing-receiving space of the transmission member including a first bearing-supporting face, a stop being threadedly engaged on the axle-tree and including a second bearing-supporting face that cooperates with the first bearing-supporting face to rotatably support the bearing.

10. The bicycle transmission assembly as claimed in claim 9, wherein the axle comprises a stepped portion, further comprising a hub mounted around the axle, the stop being turned to move transmission member to a position pressing the hub against the stepped portion.

11. The bicycle transmission assembly as claimed in claim 10, wherein the hub comprises a plurality of circumferentially spaced spoke holes.

12. The bicycle transmission assembly as claimed in claim 11, wherein the axle further comprises a second stepped portion, further comprising a second hub mounted around the axle and pressing against the second stepped portion, a bearing holder being threadedly engaged with the outer threading of the first end of the axle, the bearing holder comprising a through-hole through which the axle extends, the through-hole of the bearing holder comprising a first end for threading engagement with the outer threading of the first end of the axle, the through-hole of the bearing holder further comprising a second end defining a second bearing-receiving space for receiving a second bearing, the axle-tree extending through the second bearing-receiving space of the bearing holder, the second bearing-receiving space of the bearing holder including a third bearing-supporting face, a second stop being threadedly engaged on the axle-tree and including a fourth bearing-supporting face that cooperates with the third bearing-supporting face to rotatably support the second bearing.

13. The bicycle transmission assembly as claimed in claim 12, wherein the second stop is turned to move the bearing holder to a position pressing the second hub against the second stepped portion.

14. The bicycle transmission as claimed in claim 2, wherein the gear portion of the freewheel has eight teeth.

15. The bicycle transmission as claimed in claim 1, wherein the transmission member has fourteen teeth.

16. The bicycle transmission as claimed in claim 15, wherein the transmission member has fourteen teeth.

17. The bicycle transmission as claimed in claim 8, wherein the gear portion of the freewheel has eight teeth.

18. The bicycle transmission as claimed in claim 17, wherein the transmission member has fourteen teeth.

19. The bicycle transmission as claimed in claim 13, wherein the gear portion of the freewheel has eight teeth.

20. The bicycle transmission as claimed in claim 19, wherein the transmission member has fourteen teeth.
